(19) United States
(12) Patent Application Publication
(10) Pub. No.: US 2006/0028422 A1
(43) Pub. Date: Feb. 9, 2006

(54) Source driver and its compression and transmission method

(76) Inventor: Tae-Ho Jung, Chungcheongbuk-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/200,566

(22) Filed: Aug. 9, 2005

(30) Foreign Application Priority Data
Aug. 9, 2004 (KR) 2004-0062311

(51) Int. Cl. G09G 3/36

(52) U.S. Cl. 345/100

(57) ABSTRACT

The source driver for use in an active matrix liquid crystal display includes an input block for generating a pixel data sequence having pixel data transmitted through N numbers of channels as a unit pixel data, a multiplexing block for compressing the pixel data sequence to thereby output through a data bus having data lines corresponding to N/L numbers of channels, a shift register for generating a latch enable signal, and a line latch circuit constituted M numbers of latches receiving the pixel data inputted when the corresponding latch enable signal is inputted, wherein L, M, N are natural numbers, N is multiple number of L, and M is lager than N.

### FIELD OF INVENTION

The present invention relates to a delay locked loop (DLL) device; and, more particularly, to a DLL device which synchronizes an internal clock signal with an external clock signal.

### DESCRIPTION OF PRIOR ART

Generally, a source driver for use in a flat panel display (FPD) has been known that provides a data to a panel during one fame time. The source driver is usually called as a data driver or a column driver because the source driver drives a column line of the panel.

There are two methods for driving the source driver: a passive matrix (PM) and an active matrix (AM). The active matrix contains a thin film transistor (TFT) as a switch and a storage capacitor for storing data in each pixel. The TFT stores the electrical state of each pixel on the panel while all the other pixels are being updated. The active matrix provides a much brighter and sharper display than does the passive matrix with the same size.

FIG. 1 is a block diagram describing a conventional source driver for use in an active matrix liquid crystal display (LCD).

As shown, the conventional source driver includes an input block 20, a shift register 40, a line latch circuit 60, and an output block 80.

The input block 20 receives an inputted image data to thereby output a pixel data sequence synchronized with a data clock DCLK. The shift register 40 outputs a latch enable signal to the line latch circuit 60 sequentially based on the data clock DCLK. The line latch circuit 60 includes a plurality of latches. Each latch receives a pixel data in the pixel data sequence inputted when the corresponding latch enable signal is inputted. The output block 80 transmits outputs from the latches of the line latch circuit 60 to an output terminal.

Meanwhile, the input block 20 transmits the pixel data through a parallel data bus which is capable to transmit a predetermined numbers of channels having a plurality of data lines. For example, if the channel includes ten data lines for transmitting 10-bit pixel data and the data bus includes six channels, the data bus of the input block 20 has sixty numbers of data lines and transmits 60-bit of pixel data.

FIG. 2 is a block diagram showing the shift register 40, shown in FIG. 1, where the data bus has the data lines corresponding to N channels.

The plural data lines of the parallel data bus occupy too large area to be implemented at inside of the semiconductor device and, therefore, make it hard to design a high integration device. Further, a fabrication cost is also increased.

### SUMMARY OF INVENTION

It is, therefore, an object of the present invention to provide a source driver reducing an area occupied by plural data lines to thereby reduce the fabrication cost.

In accordance with an aspect of the present invention, there is provided a source driver for use in an active matrix liquid crystal display includes an input block for generating a pixel data sequence having pixel data transmitted through N numbers of channels as a unit pixel data, a multiplexing block for compressing the pixel data sequence to thereby output through a data bus having data lines corresponding to N/L numbers of channels, a shift register for generating a latch enable signal, and a line latch circuit constituted M numbers of latches receiving the pixel data inputted when the corresponding latch enable signal is inputted, wherein L, M, N are natural numbers, N is multiple number of L, and M is lager than N.

In accordance with another aspect of the present invention, there is provided a compression and transmission method for an image signal includes the steps of: (a) generating a unit pixel data synchronized with a clock, (b) separating the unit pixel data into a first pixel data block and a second pixel data block, (c) transmitting the first pixel data block to a line latch circuit when the clock is high, and (d) transmitting the second pixel data block to the line latch circuit when the clock is low.

### BRIEF DESCRIPTION OF THE DRAWINGS

The above and other objects and features of the present invention will become apparent from the following description of preferred embodiments taken in conjunction with the accompanying drawings, in which:

FIG. 1 is a block diagram describing a conventional source driver circuit for an active matrix liquid crystal display (LCD);

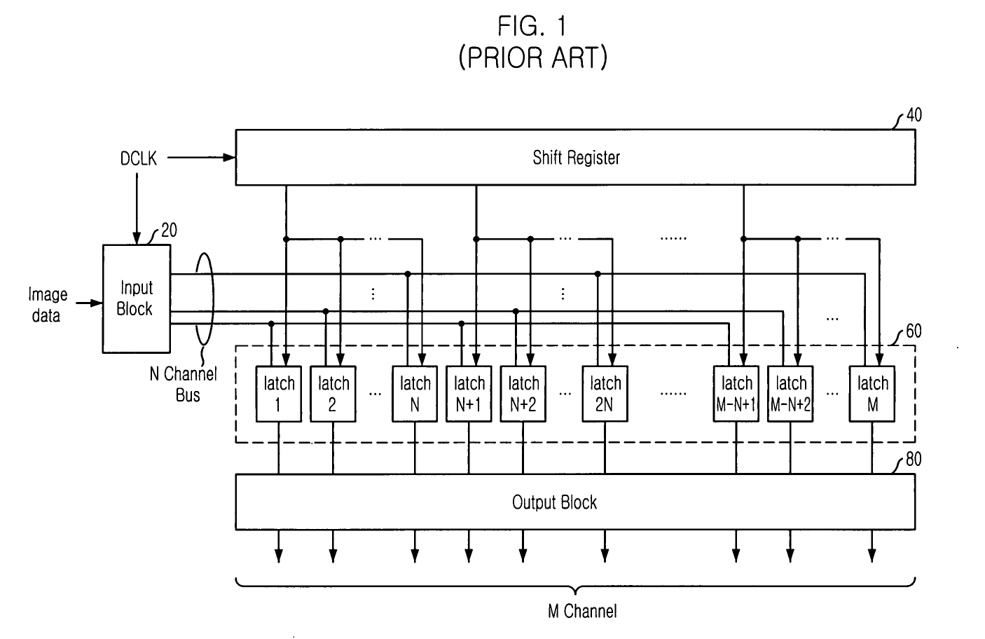

FIG. 2 is a block diagram showing a shift register, shown in FIG. 1, where data bus has data lines corresponding to N channels of pixel data;

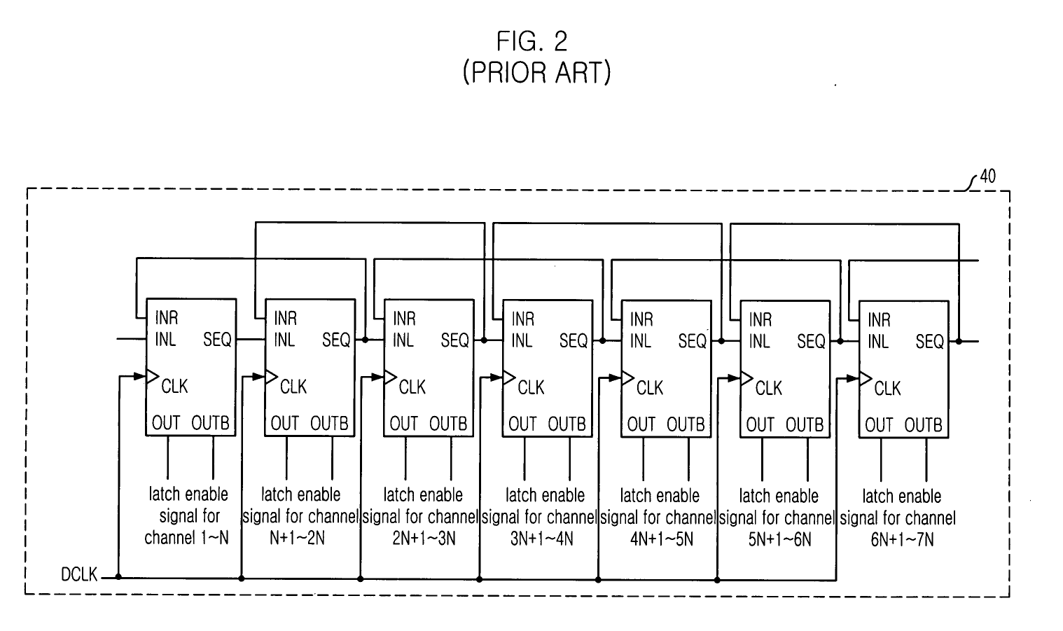

FIG. 3 is a block diagram describing a source driver circuit for an active matrix LCD in accordance with a preferred embodiment of the present invention;

FIG. 4 is a block diagram depicting a multiplexer (MUX) having six input data lines shown in FIG. 3;

FIG. 5 is a schematic circuit diagram showing a 2×1 MUX 210A shown in FIG. 4;

FIG. 6 is a block diagram showing a shift register shown in FIG. 3;

FIG. 7 is a schematic circuit diagram depicting a flip-flop shown in FIG. 6;

FIG. 8 is a block diagram describing an internal clock generator for generating a data clock and a half clock.

### DETAILED DESCRIPTION OF INVENTION

Hereinafter, a source driver for use in an active matrix liquid crystal display (LCD) in accordance with the present invention will be described in detail referring to the accompanying drawings.

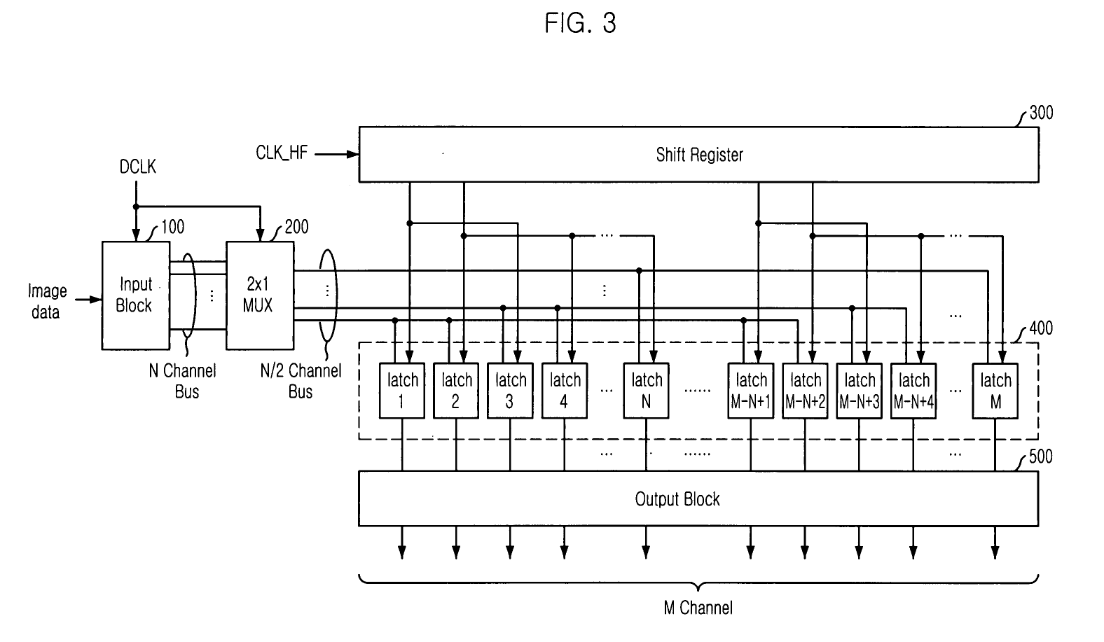

FIG. 3 is a block diagram describing a source driver for an active matrix LCD in accordance with a preferred embodiment of the present invention.

As shown, the source driver includes an input block 100, a multiplexer (MUX) 200, a shift register 300, a line latch circuit 400, and an output block 500.

The input block 100 receives a data clock DCLK and an image data to thereby generate a pixel data sequence. The pixel data sequence has plural pixel data transmitted through N channels as a continuously outputted data unit. The MUX 200 compresses the N channels of pixel data to thereby output N/2 channels of pixel data by performing a time multiplexing. The shift register 300 receives a half clock CLK_HF to thereby output a latch enable signal to the line latch circuit 400 sequentially. The line latch circuit 400 is provided with a plurality of latches. Each latch receives one of the pixel data inputted when the corresponding latch enable signal is inputted. The output block 500 receives an output data from the line latch circuit 400 and performs an image rectification process before outputting an image data through M number of output channels.

Herein, the N and M are natural numbers and M is a multiple number of N. Further, the half clock CLK_HF has a half period of the data clock DCLK.

Hereinafter, it is presumed for a convenience of explanation that the input block outputs the pixel data through six channels, i.e., six is substituted for N, and the bit number of pixel data transmitted once through one channel is 10.

The input block 100 performs a voltage level regulation and timing controlling to thereby output 60-bit pixel data corresponding to 6 channels to the MUX 200 through a first data bus having a 60-bit band width in a parallel manner. The input block 100 outputs the 60-bit pixel data during one clock period of the data clock DCLK.

The MUX 200 performs a time multiplexing process with the 60-bit pixel data inputted through the first data bus to thereby output through a second data bus having a 30-bit. The MUX 200 outputs a 30-bit pixel data during a half cycle of the data clock DCLK and, therefore, can output total 60-bit pixel data during one cycle of the data clock DCLK.

The shift register 300 outputs the latch enable signal to the latches for receiving the pixel data transmitted through one channel when the pixel data corresponding to the channel are loaded to the second data bus. Whereas the conventional shift register 40 outputs one latch enable signal to the six latches corresponding to the one unit of pixel data transmitted per one cycle of the data clock DCLK, the shift register 300 of the present invention outputs two latch enable signal per one cycle of the data clock DCLK because each data line constituting the second data bus loads consecutive two pixel data during one cycle of the data clock DCLK. Therefore, the shifter register 300 outputs one latch enable signal to the corresponding three latches during half cycle of the data clock DCLK.

The line latch circuit 400 latches the pixel data loaded to the second data bus in response to the latch enable signal outputted from the shift register 300. Whereas the conventional line latch circuit 60 receives the pixel data through the 60-bit data bus corresponding to six channels, the line latch circuit 400 of the present invention receives the pixel data through the second data bus having 30-bit bandwidth. In other words, in the present invention, each two channels of the six channels share the common data bus and, therefore, the line latch circuit 400 receives the sixty pixel data through three channels.

The output block 500 receives an output data from the line latch circuit 400 and performs an image rectification process such as a bright adjustment, a contrast adjustment, and gamma adjustment before outputting an image data through the M output channels.

Further, source driver according to the abovementioned embodiment of the present invention includes a clock generator for generating an internal clock by adjusting a period of an external clock properly.

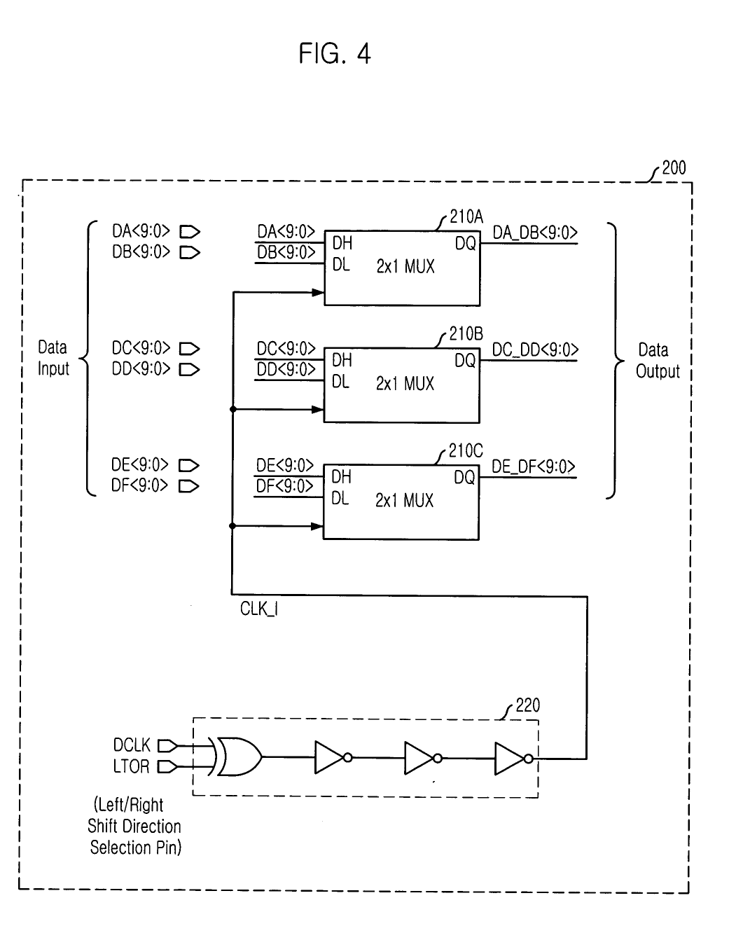

FIG. 4 is a block diagram depicting the MUX 200 having six input data lines shown in FIG. 3.

As shown, the MUX 200 includes three 2×1 MUXs 210A, 210B, and 210C and clock regulator 220. Each of the 2×1 MUXs 210A, 210B, and 210C receives input signals, i.e., two channels of pixel data through a first input terminal DH and a second input terminal DL, respectively. Then, each of the 2×1 MUXs 210A to 210C outputs the input signal inputted through the first input terminal DH when an internal clock CLK_I is high level and outputs the input signal inputted through the second input terminal DL when the internal clock CLK_I is low level. The input signals are outputted through an output terminal DQ.

Further, the clock regulator 220 receives a clock direction signal LTOR and the data clock DCLK and provides the internal clock CLK_I to the three 2×1 MUXs 210A to 210C. The clock regulator 220 generates the internal clock CLK_I having the same waveform with the data clock DCLK when the clock direction signal LTOR is a logic high level. Meanwhile, the internal clock CLK_I has an inversed waveform with the data clock DCLK when the clock direction signal LTOR is a logic low level.

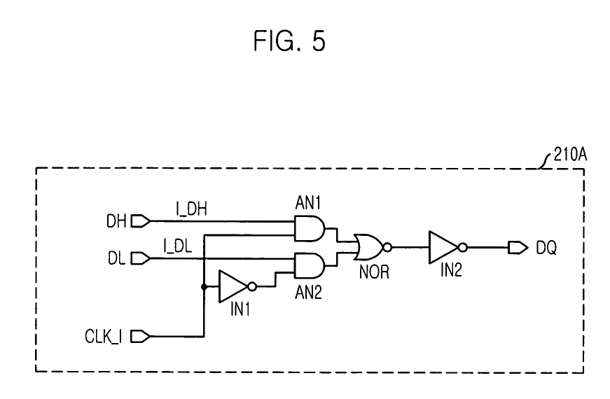

FIG. 5 is a schematic circuit diagram showing the 2×1 MUX 210A shown in FIG. 4.

As shown, the 2×1 MUX 210A is provided with a first and a second AND gates AN1 and AN2, a first and a second inverters IN1 and IN2, and a NOR gate NOR. The first AND gate AN1 receives a first input signal I_DH inputted through the first input terminal DH and the internal clock CLK_I. The first inverter IN1 inverts the internal clock CLK_I. The second AND gate AN2 receives a second input signal I_DL inputted through the second input terminal DL and an output from the first inverter IN1, i.e., an inverted internal clock. The NOR gate NOR receives outputs from the first and the second AND gates AN1 and AN2. The second inverter IN2 inverts an output from the NOR gate NOR to thereby output through the output terminal DQ.

Herein, the 2×1 MUX 210A can be implemented with a switch instead of the abovementioned logic gates. However, for transmitting logical states more precisely, the structure shown in FIG. 5 is preferred.

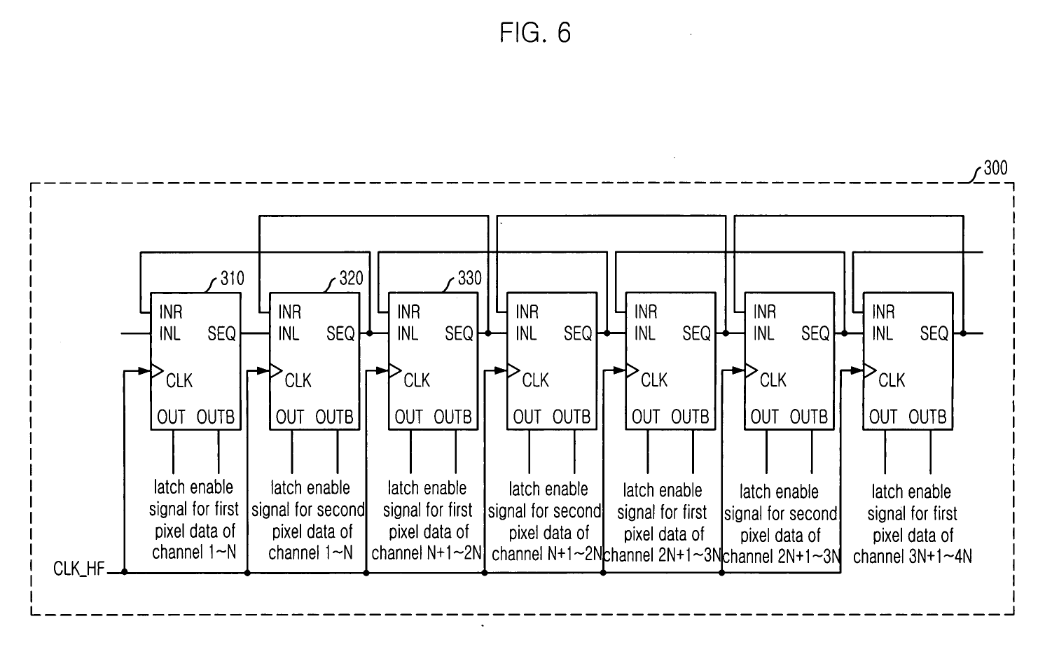

FIG. 6 is a block diagram showing the shift register 600 shown in FIG. 3.

As shown, the shift register 300 is provided with a plurality of flip-flop blocks. Each of the flip-flop block outputs the latch enable signal synchronized with the half clock CLK_HF. The latch enable signal outputted from one flip-flop enables three, i.e., 2/N, latches in the line latch circuit 400. That is, a first latch enable signal outputted from a first flip-flop block 310 at a first period of the half clock CLK_HF enables first, third, and fifth latches in the line latch circuit 400. Then, a second latch enable signal outputted from a second flip-flop block 320 at a second period of the half clock CLK_HF enables second, fourth, and sixth latches. Subsequently, a third latch enable signal outputted from a third flip-flop block 330 at a third period of the half clock CLK_HF inputted to the line latch circuit 400 to thereby enable seventh, ninth, eleventh latches. Through abovementioned method, the shift register 300 enables the latches in the line latch circuit 400 sequentially.

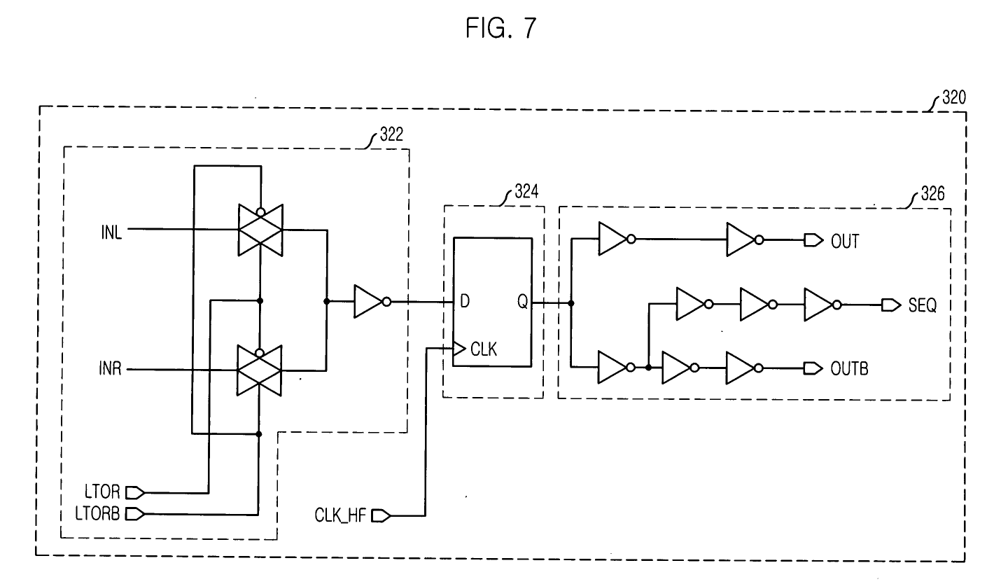

FIG. 7 is a schematic circuit diagram depicting the flip-flop 320 shown in FIG. 6.

As shown, the flip-flop 320 constituting the shift register 300 is provided with an input circuit 322, a flip-flop 324, and an output circuit 326.

The input circuit 322 receives a previous input INL when the clock direction signal LTOR is high and receives a next input INR when the clock direction signal LTOR is low. Herein, the previous input refers a sequence output SEQ from a previous flip-flop block and the next input refers an sequence output SEQ from a next flip-flop block. For example, the second flip-flop block 320 receives the sequence output SEQ from the first flip-flop block 310 as the previous input INL and receives the sequence output SEQ from the third flip-flop block 330 as the next input INR. The flip-flop 324 receives an output from the input circuit synchronized with the half clock CLK_HF. The output circuit 326 delays an output from the flip-flop 324 to thereby output as the sequence output SEQ and a first and a second outputs OUT and OUTB. The output circuit 326 delays the output from the flip-flop 324 for a predetermined time in order to secure a margin for reliable operation and to prevent a clock skew.

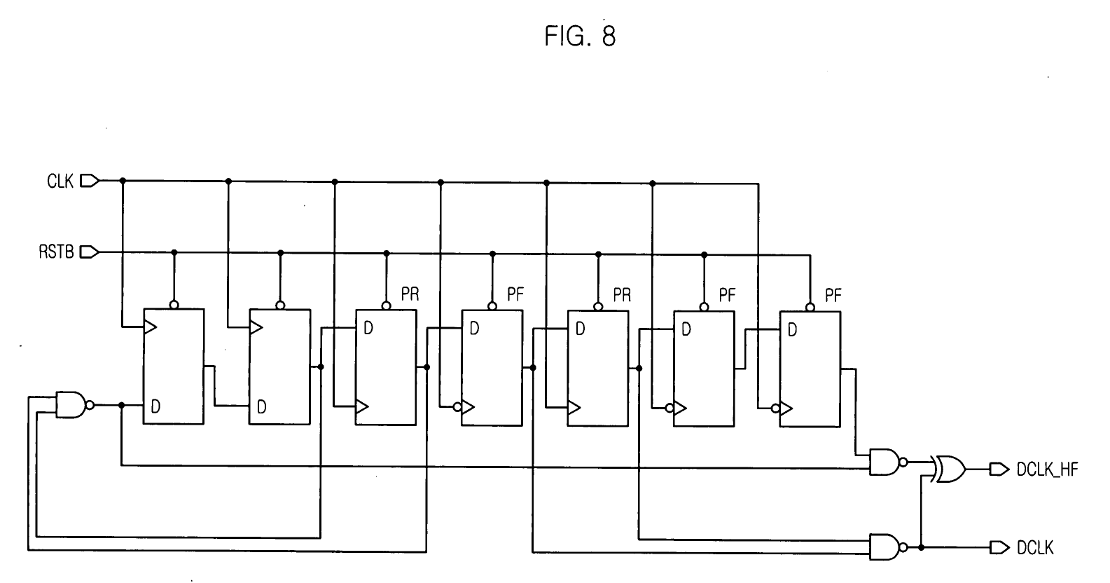

FIG. 8 is a block diagram describing an internal clock generator for generating the data clock DCLK and the half clock CLK_HF.

As shown, the internal voltage generator receives an external clock CLK to thereby generate the data clock DCLK and the half clock CLK_HF having half period of the data clock DCLK. A period of the data clock DCLK is five times of a period of the external clock CLK and, therefore, a period of the half clock CLK_HF is two and a half times of the period of the external clock CLK.

Hereinafter, the operation of the source driver of the present invention is explained.

The operation includes the following steps of: (a) generating a unit pixel data synchronized with the data clock DCLK; (b) separating the unit pixel data into a first pixel data block and a second pixel data block; (c) transmitting the first pixel data block to the line latch circuit when the data clock DCLK is high; (d) transmitting the second pixel data block to the line latch circuit when the data clock DCLK is low.

Step (a) is performed in the input block 100 shown in FIG. 3. Because the unit pixel data is separated in step (b), the unit pixel data is preferred to have pixel data corresponding to even numbers of channels. For example, in the abovementioned embodiment of the present invention, the sixty pixel data transmitted through the six channels forms one unit pixel data.

Step (b) is performed in the MUX 200 shown in FIG. 3. In the abovementioned embodiment, the 2×1 MUX is used to separate the unit pixel data into the first pixel data block and the second pixel data block by performing the time multiplexing. Referring to FIG. 4, the 60-bit of unit pixel data constituted with DA<9:0> to DF<9:0> are separated into the first data block constituted with DA<9:0>, DC<9:0>, and DE<9:0> and the second data block constituted with DB<9:0>, DD<9:0>, and DF<9:0>.

Step (c) is performed when the unit pixel data is transmitted from the MUX 200 to the line latch circuit 400 through the second data bus having half numbers of data line of the unit data pixel, i.e., 30-bit.

In the abovementioned embodiment, the present invention is explained when N is six and the number of data line of the channel is ten and when the number of the unit pixel data is sixty. However, the number of channels, i.e., N, and the number of data line constituting the channel can be varied depending on the requirements of display.

The source driver of the present invention transmits two pixel data during one clock period by using 2×1 MUX to thereby perform the time multiplexing. That is, a first pixel data is transmitted when the clock is high and a second pixel data is transmitted when the clock is low. Therefore, the present invention transmits the pixel data two times faster than the conventional source driver which transmits one pixel data during one clock period.

Further, when the source driver transmits pixel data corresponding N channels, the present invention is able to transmit the unit pixel data from the input block to the line latch circuit through N/2 channels.

Thus, the present invention contributes to reduce the area requiring for the data lines, to simplify the fabrication process of the data lines, and to reduce the fabrication cost.

The present application contains subject matter related to Korean patent application No. 2004-62311, filed in the Korean Patent Office on Aug. 9, 2004, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. The source driver for use in an active matrix liquid crystal display, comprising:
an input block for generating a pixel data sequence having pixel data transmitted through N numbers of channels as a unit pixel data;
a multiplexing block for compressing the pixel data sequence to thereby output through a data bus having data lines corresponding to N/L numbers of channels;
a shift register for generating a latch enable signal; and
a line latch circuit constituted M numbers of latches receiving the pixel data inputted when the corresponding latch enable signal is inputted,
wherein L, M, N, N/L are natural numbers, and M is lager than N.

2. The source driver as recited in claim 1, wherein the shift register outputs the latch enable signals L times per one clock.

3. The source driver as recited in claim 1, wherein the multiplexing block includes a 2×1 MUX receiving an internal clock to thereby output a first pixel data when the clock is high and output a second pixel data when the clock is low, wherein the first and the second pixel data is from the pixel data sequence.

4. The source driver as recited in claim 3, wherein the 2×1 MUX includes:
a first AND gate for receiving the first pixel data and the internal clock;
a first inverter for inverting the internal clock;
a second AND gate for receiving the second pixel data and an output from the first inverter;
a NOR gate for receiving outputs from the first and the second AND gates; and
a second inverter for inverting an output from the NOR gate.

5. The source driver as recited in claim 3, wherein the multiplexing block further includes a clock regulator for receiving the clock and a clock direction signal to thereby output the clock as the internal clock when the clock direction signal is high and output the inverted clock as the internal clock when the clock direction signal is low.

6. The source driver as recited in claim 5, wherein the clock regulator includes an XOR gate for receiving the clock and the clock direction signal.

7. The source driver as recited in claim 1, wherein the shift register is provided with a plurality of flip-flop blocks serially connected one another and operated in response to a half clock whose period is half of the clock.

8. The source driver as recited in claim 7, wherein the flip-flop block includes an input circuit for receiving an output from a previous flip-flop block when the clock direction signal is high and receiving an output from a next flip-flop block when the clock direction signal is low.

9. The source driver as recited in claim 1, further comprising a clock generator for generating the clock and the half clock having half period of the clock.

10. An image data transmission method by using a source driver, comprising the steps of:
(a) generating a pixel data sequence having pixel data transmitted through N numbers of channels as a unit pixel data;
(b) compressing the pixel data sequence to thereby output through a data bus having data lines corresponding to N/L numbers of channels;
(c) generating a latch enable signal;
(d) receiving the pixel data in response to the latch enable signal, wherein L, N, N/L are natural numbers, and M is larger than N.

11. The image data transmission method as recited in claim 10, wherein step (b) includes the steps of:
(b1) separating the unit pixel data into a first pixel data block and a second pixel data block;
(b2) transmitting the first pixel data block to a line latch circuit when the clock is a logic high level; and
(b3) transmitting the second pixel data block to the line latch circuit when the clock is a logic low level.

12. The compression and transmission method as recited in claim 11, wherein the unit pixel data includes a predetermined number of pixel data.

13. The compression and transmission method as recited in claim 11, wherein steps (b2) and (b3) are performed through a common internal data bus.

14. The compression and transmission method as recited in claim 11, wherein steps (b2) and (b3) are performed through an internal data bus having a half data lines of the unit pixel data.
